(19) United States
(12) Patent Application Publication
(10) Pub. No.: US 2007/0199811 A1
(43) Pub. Date: Aug. 30, 2007

(54) Method For Producing Cover Part Of Push Button Switch And Cover Member For Push Button Switch

(75) Inventors: Shinji Hotta, Saitma (JP); Kazunobu Yokoyama, Saitama (JP)

Correspondence Address: OSHA LIANG L.L.P., 1221 MCKINNEY STREET, SUITE 2800, HOUSTON, TX, 77010, US

(73) Assignee: SHIN-ETSU POLYMER CO., LTD., Chuo-ku, Tokyo (JP)

(21) Appl. No.: 11/632,378

(22) PCT Filed: Jul. 7, 2005
(86) PCT No.: PCT/JP05/12603

§ 371 Date: Jan. 12, 2007

(30) Foreign Application Priority Data
Jul. 12, 2004 (JP) 2004-205077

(51) Int. Cl. H01H 9/00

(52) U.S. Cl. 200/310

(57) ABSTRACT

Unevenness in light-emission on the illuminated light is prevented, and deterioration in click-feeling is prevented. An EL element 5 is sandwiched and formed between a silicone rubber sheet 4a, to which a key top part 2 is fixed via an adhesion layer 3, and a silicone rubber sheet 4b having a protrusion 41. Formation of the EL element 5 on the silicone rubber sheet is done after applying the surface-modification treatment onto a surface of at least one of the silicone rubber sheets 4a, 4b for forming the EL element 5.

### TECHNICAL FIELD

The present invention relates to a method for producing cover part of a push button switch having an illumination function, used for electronics apparatuses, and to a cover member for a push button switch.

### BACKGROUND ART

Cover members for push button switch used in input section of, for example, cell-phones are conventionally provided with an illumination function to illuminate the key top part structuring the pushbutton in order to ensure visibility at a dark place. This allows a user to readily recognize the function of individual pushbuttons even on using the cell-phone at dark places.

Patent Document 1 discloses a technology relating to a push button switch which uses an EL (electroluminescent) panel as the member of providing the above illumination function. The EL panel of the pushbutton switch has a hole allowing a protrusion formed at a lower section of the key top part to penetrate therethrough, (refer to FIG. 4 of Patent Document 1).

Patent Document 2 discloses a technology relating to a pushbutton switch member in which the key top part is formed by a resin film.

[Patent Document 1] Japanese Patent Application Laid-Open No. 2003-068161

[Patent Document 2] Japanese Patent Application Laid-Open No. 2002-015639

### DISCLOSURE OF THE INVENTION

Problems to be Solved by the Invention

According to the pushbutton switch member described in Patent Document 1, the protrusion penetrates through the hole opened on the EL element. Consequently, a portion of the light emitted from the EL panel for illuminating the key top part is blocked by the protrusion. As a result, the shadow of the protrusion appears on the key top part, which induces unevenness in light-emission.

Since the pushbutton switch member described in Patent Document 2 has the key top part made of a rigid resin film, the click-feeling on pressing the key top part deteriorates unless a portion of the resin film is trimmed by notching.

An object of the present invention is to solve the above problems, thus to provide a method for manufacturing pushbutton switch cover member for preventing unevenness in light-emission on the illuminated light and for preventing deterioration of click-feeling, and to provide a pushbutton switch cover member therefor.

Means to Solve the Problems

The method for manufacturing pushbutton switch cover member according to the present invention is the method for manufacturing pushbutton switch cover member having an illumination function, which method has: the first step of modifying any of the surfaces of an elastic layer consisting essentially of an elastic material; the second step of forming an EL element on the modified surface of the elastic layer; the third step of forming a rubber sheet on a surface of thus formed EL element; and the fourth step of fixing a key top part onto a surface of thus formed elastic layer, wherein a protrusion is formed on a surface of the rubber sheet opposite to the surface thereof adhering to the EL element.

Since the present invention forms the EL element between the key top part and the protrusion, the light emitted from the EL element can illuminate the key top part without blocked by the protrusion. That is, the unevenness in light-emission on the illuminated light can be prevented. In addition, since the soft EL element is formed being sandwiched between the elastic layer and the rubber sheet, both of which having elasticity, an adequate click-feeing is maintained without applying notching to the rubber sheet and the like. That is, the deterioration of click-feeling can be prevented. Furthermore, since the formation of EL element on the elastic layer is done after applying the surface modification to the surface of the elastic layer, the wet tension of the elastic layer can be increased, thereby allowing readily forming the EL element on the elastic layer.

The method for producing the cover member for push button switch according to the present invention is a method for manufacturing pushbutton switch cover member having an illumination function, which method has: the first step of modifying one having no protrusion formed thereon of a rubber sheet, which rubber sheet forms the protrusion on the other surface thereof; the second step of forming an EL element on the modified surface of the rubber sheet; the third step of forming an elastic layer consisting essentially of an elastic material on a surface of thus formed EL element; and the fourth step of fixing a key top part onto a surface of thus formed elastic layer.

Since the present invention forms the EL element between the key top part and the protrusion, the light emitted from the EL element can illuminate the key top part without blocked by the protrusion. That is, the unevenness in light-emission on the illuminated light can be prevented. In addition, since the soft EL element is formed being sandwiched between the elastic layer and the rubber sheet, both of which have elasticity, an adequate click-feeing is maintained without applying notching to the rubber sheet and the like. That is, the deterioration of click-feeling can be prevented. Furthermore, the formation of EL element on the rubber sheet is done by firstly applying the surface modification to the surface of the rubber sheet, then by forming the EL element on the modified surface of the rubber sheet. As a result, the wet tension of the rubber sheet can be increased, thereby allowing readily forming the EL element on the rubber sheet.

The method for manufacturing pushbutton switch cover member according to the present invention is a method for manufacturing pushbutton switch cover member having an illumination function, which method has: the first step of forming a urethane layer on one surface having no protrusion formed thereon of a rubber sheet, which rubber sheet forms the protrusion on the other surface thereof; the second step of forming an EL element on a surface of thus formed urethane layer; the third step of forming an elastic layer consisting essentially of an elastic material on a surface of thus formed EL element; and the fourth step of fixing a key top part onto a surface of thus formed elastic layer.

Since the present invention forms the EL element between the key top part and the protrusion, the light emitted from the EL element can illuminate the key top part without blocked by the protrusion. That is, the unevenness in light-emission on the illuminated light can be prevented. In addition, since the soft EL element is formed being sandwiched between the elastic layer and the rubber sheet, both of which having elasticity, an adequate click-feeing is maintained without applying notching to the rubber sheet and the like. That is, the deterioration of click-feeling can be prevented. Furthermore, the formation of EL element on the rubber sheet is done by firstly forming the urethane layer on the surface of the rubber sheet, then by forming the EL element on the surface of the urethane layer. As a result, the adhesion between the rubber sheet and the EL element increases to improve the adhesiveness.

The above described first step is preferably conducted either by modifying a surface of the rubber sheet, on the surface not forming the protrusion, and forming the urethane layer on the modified surface, or by applying a primer on the modified surface, and forming the urethane layer on the primer-applied surface. Also the first step is preferably conducted by applying a primer on a surface of the rubber sheet, on the surface not forming the protrusion, and forming the urethane layer on the primer-applied surface. With these steps, the adhesiveness of the rubber sheet with the EL element can further be improved.

The pushbutton switch cover member according to the present invention is a pushbutton switch cover member having an illumination function, having: a rubber sheet having a protrusion formed at a lower surface side thereof; an EL element being formed at an upper surface side of the rubber sheet; an elastic layer being formed on an upper surface side of the EL element and consisting essentially of an elastic material; and a key top part being adhered to an upper surface side of the elastic layer. The elastic material is preferably a silicone rubber, a thermoplastic elastomer, or a urethane-based resin.

Since the present invention forms the EL element between the key top part and the protrusion, the light emitted from the EL element can illuminate the key top part without blocked by the protrusion. That is, the unevenness in light-emission on the illuminated light can be prevented. In addition, since the soft EL element is formed being sandwiched between the elastic layer and the rubber sheet, both of which having elasticity, an adequate click-feeing is maintained without applying notching to the rubber sheet and the like. That is, the deterioration of click-feeling can be prevented.

Effect of the Invention

The method for manufacturing pushbutton switch cover member and the pushbutton switch cover member according to the present invention prevent the unevenness in light-emission on the illuminated light and prevent the deterioration of click-feeling.

### BRIEF DESCRIPTION OF THE DRAWINGS

FIG. 1 is a cross sectional view of a pushbutton switch cover member according to a first embodiment of the present invention.

FIG. 2 is a cross sectional view of an EL element structuring the pushbutton switch cover member of FIG. 1.

FIG. 3 is a cross sectional view of individual members to illustrate the manufacturing process of the pushbutton switch cover member of Example 1.

FIG. 4 is a cross sectional view of individual members to illustrate the manufacturing process of the pushbutton switch cover member of Example 1.

FIG. 5 explains the wet tension on a silicone rubber sheet before and after UV treatment in examples.

FIG. 6 is a cross sectional view of individual members to illustrate the manufacturing process of the pushbutton switch cover member of Example 2.

FIG. 7 is a cross sectional view of individual members to illustrate the manufacturing process of the pushbutton switch cover member of Example 2.

FIG. 8 is a plan view of the pushbutton switch cover member, illustrating a detail structural example for the case that the pushbutton switch cover member is used for a pushbutton switch of a cell-phone.

FIG. 9 is a plan view illustrating individual layers structuring the EL element in the pushbutton switch cover member shown in FIG. 8.

FIG. 10 is a cross sectional view of the pushbutton switch cover member according to the second embodiment.

### DESCRIPTION OF THE REFERENCE SYMBOLS

1: Pushbutton switch cover member

2: Key top part

3: Adhesion layer

4a, 4b: Silicone rubber sheet

41: Protrusion

5: EL element

7: Urethane layer

51: Counter electrode

52: Dielectric layer

53: Light-emitting layer

54: Transparent electrode

55: Auxiliary electrode

### BEST MODES FOR CARRYING OUT THE INVENTION

The embodiments of the pushbutton switch cover member according to the present invention are described below referring to the drawings. The same element in the drawings has the same reference symbol, and duplicated description is omitted.

### First Embodiment

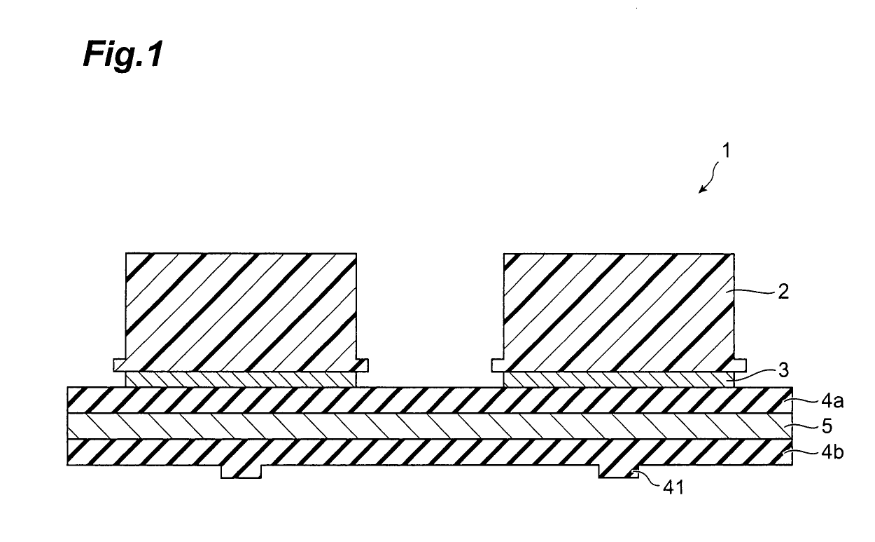

The first embodiment of the present invention is described below. FIG. 1 is a cross sectional view of the pushbutton switch cover member according to the first embodiment. As shown in FIG. 1, the pushbutton switch cover member 1 has a key top part 2, an adhesion layer 3, silicone rubber sheets 4a, 4b, and an EL element 5.

The silicone rubber sheets 4a, 4b are formed at the upper surface side and the lower surface side of the EL element, respectively. The adhesion layer 3 is formed on the upper surface side of the silicone rubber sheet 4a formed on the upper surface side of the EL element 5. The key top part 2 is fixed to the upper surface of the silicone rubber sheet 4a by the adhesion layer 3. A protrusion 41 to press the movable contact (not shown) is formed on the lower surface of the silicone rubber sheet 4b formed on the lower surface side of the EL element 5.

The EL element 5 of the pushbutton switch cover member 1 shown in FIG. 1 is covered by the silicone rubber sheets 4a, 4b over the whole area of both surfaces thereof. The coverage is not limited to that configuration, and the whole surface area of the EL element 5 may be covered by the silicone rubber sheet, for example. That is, the EL element 5 may be enclosed by the silicone rubber sheet. The material to sandwich the EL element 5 is not limited to the silicone rubber sheet, and any material is applicable if only it is a rubber sheet. Furthermore, the portion corresponding to the silicone rubber 4a in FIG. 1 is not limited to the rubber sheet, and any material is applicable if it is an elastic layer consisting essentially of an elastic material such as silicone rubber, thermoplastic elastomer, and urethane-based resin. The material to structure the elastic layer is preferably the one having 90 or lower IRHD (International Rubber Hardness Degrees), and more preferably 60 or lower. The elastic layer is only required to be structured as a layer in the pushbutton switch cover member 1 being formed in a layered structure. Therefore, the elastic layer may be layered structure, or may be in a thin film shape or a sheet shape, for example. The applicable method to form that type of elastic layer includes the molding method such as compression molding and injection molding, the wet process such as screen printing, and the pasting method using an adhesive.

When the above elastic layer is formed by a film made of urethane and the like having low hardness, or by an ink printing layer using a binder of low hardness material such as urethane, the attained click-feeling becomes equivalent to that attained in the case of forming by silicone rubber, and the obtained layer thickness becomes smaller than that of the silicone rubber forming. As a result, a thin film design is attained.

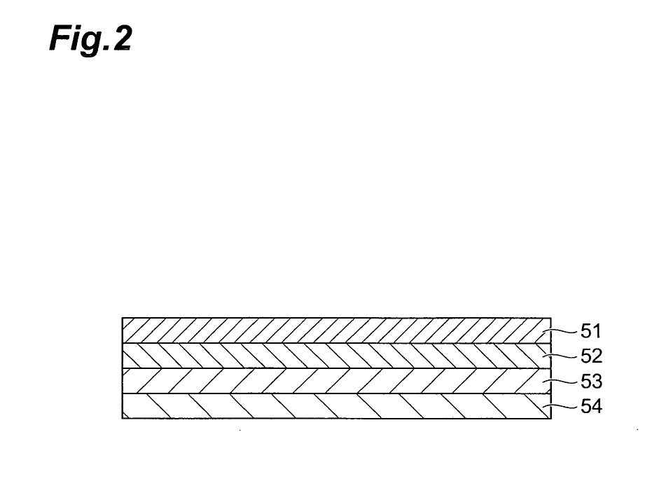

The EL element 5 is described referring to FIG. 2. As seen in FIG. 2, the EL element 5 has a counter electrode 51, a dielectric layer 52, a light-emitting layer 53, and a transparent electrode 54.

The counter electrode 51 is formed by a conductive film prepared by dispersing a conductive filler, such as metal or alloy of gold, silver, copper, nickel, and the like, carbon black, and graphite, into a resin, a rubber, or a copolymer of polyester-based, acrylic-based, urethane-based, silicone-based, or epoxy-based resin. The counter electrode 51 may be formed by a metallic film made of metal or alloy of gold, silver, copper, nickel, or the like, or a composite film thereof. The composite film is formed by, for example, electrodeposition, transcription, chemical plating, or vapor deposition.

The dielectric layer 52 is formed by dispersing a dielectric powder such as barium titanate powder and titanium oxide powder into a binder. The applicable binder includes a fluororesin, a synthetic rubber, a polyester resin, an acrylic resin, an epoxy resin, or a copolymer of them.

The light-emitting layer 53 is formed by, for example, dispersing an inorganic fluorescent powder such as zinc sulfide, on which a moisture-proof film is coated, into the binder. The applicable binder includes, similar to the binder of dielectric layer 52, a fluororesin, a synthetic rubber, a polyester resin, an acrylic resin, an epoxy resin, or a copolymer of them. By selecting a binder having high dielectric constant, the light-emitting layer 53 becomes capable of emitting the light at higher brightness.

The transparent electrode 54 is formed by a conductive polymer. The transparent electrode 54 is, however, preferably formed by a derivative of polypyrrole, polythiophene, or polyaniline, having transparency and high conductivity. If needed, an opaque auxiliary electrode may be wired by laminating thereof at least in a part on the surface of the transparent electrode 54 at opposite side (at the side of the light-emitting layer 53) to the light-emitting zone side (the lower surface side of the transparent electrode 54 in FIG. 2). With the wiring of the auxiliary electrode, the power feed can be improved, and the conductivity of the transparent electrode 54 is compensated. The material forming the auxiliary electrode may be similar one to the above-described material that forms the counter electrode 51.

The pushbutton switch cover member 1 having the above structure is characterized in that the EL element 5 is formed between the key top part 2 and the protrusion 41, and that the EL element 5 is formed being sandwiched between the silicone rubber sheets 4a, 4b. With the structure, the light emitted from the EL element 5 illuminates the key top part, not blocked by the protrusion 41, thereby preventing the unevenness in light-emission on the illuminated light. Since the silicone rubber sheets 4a, 4b supporting the key top part 2 sandwich only the soft EL element 5, the deterioration of click-feeling does not occur even without applying the notching.

In general, silicone rubber has small wet tension. Accordingly, on forming the EL element on the silicone rubber, the ink forming the EL element may be repelled by the silicone rubber. That is, it is difficult to form EL element on the silicone rubber. Therefore, a common practice is to form a resin sheet on the silicone rubber, then to form the EL element on the resin sheet. The wet tension is defined as follows. A variety of mixtures each giving sequentially different surface tensions are applied onto the surface of respective specimens to determine the wet condition of the surface of the specimens. Among the mixtures that wetted the surface of the specimen, the maximum surface tension is selected as the wet tension.

Generally, however, a resin sheet is rigid so that the formation of resin sheet on the silicone rubber deteriorates the click-feeling on pressing the key top.

To this point, according to the pushbutton switch cover member 1 of the embodiment, when forming the EL element 5 on the silicone rubber sheets 4a, 4b, the surface modification treatment is given to the silicone rubber sheets 4a, 4b before forming the EL element thereon.

By the procedure, the wet tension of the silicone rubber sheet increases, and the EL element can be easily formed on the silicone rubber sheet. That is, the EL element can be formed on the silicone rubber sheet without applying the rigid resin film. As a result, the pushbutton switch cover member 1 of the embodiment maintains a favorable click-feeling without applying notching.

Furthermore, elimination of notching assures the wiring space in the silicone rubber sheet utilizing the untrimmed zone therein. As a result, the number of wirings can be increased, and, for example, illuminating only a specified key top part 2 becomes available.

### EXAMPLE 1

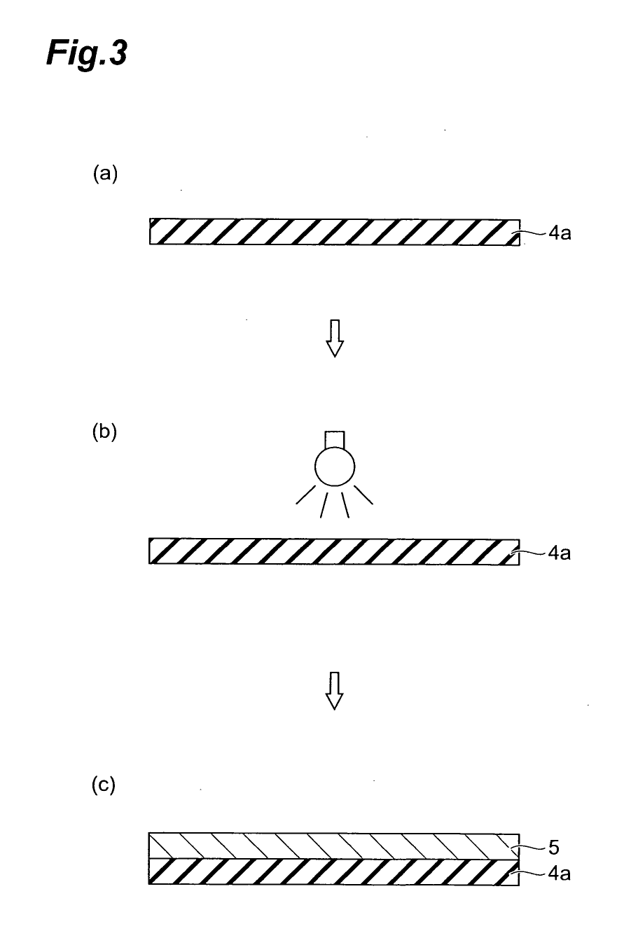

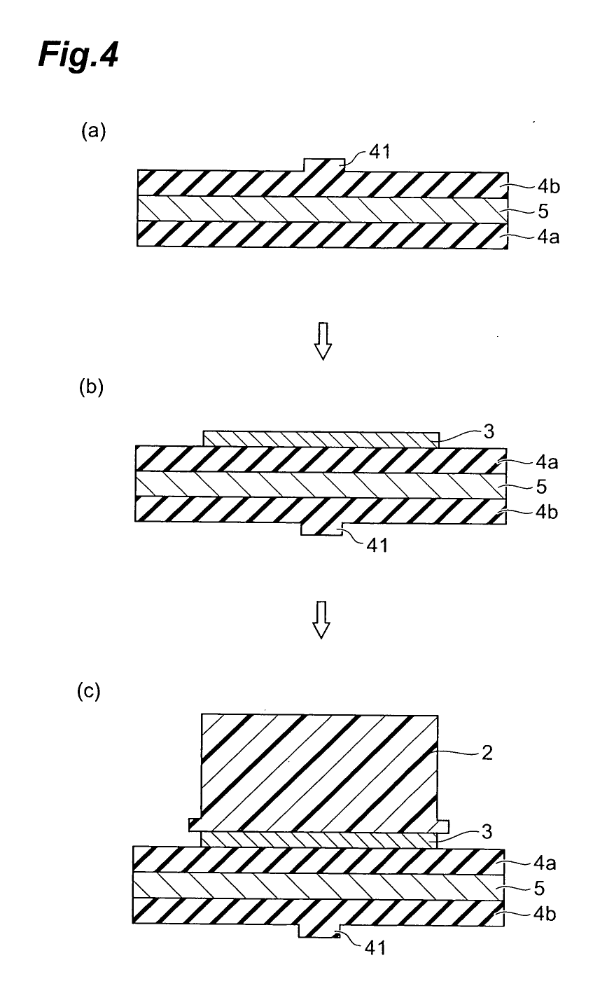

Referring to FIG. 3 and FIG. 4, Example 1 of the pushbutton switch cover member of the first embodiment is described.

First, into a specified mold, there was filled a blended raw material mixture of 100 parts by weight of silicone rubber “KE-951U”, (trade name, manufactured by Shin-Etsu Chemical Co., Ltd.), 1 part by weight of crosslinking agent “C-8B”, (trade name, manufactured by Shin-Etsu Chemical Co., Ltd.), and 0.004 parts by weight of “Color MB”, (trade name, manufactured by Shin-Etsu Chemical Co., Ltd.). The raw material mixture filled in the mold was heated and pressed at 180° C. under 200 kgf/cm² for 5 minutes, thus obtained the silicone rubber sheet 4a shown in FIG. 3(a).

Then, as shown in FIG. 3(b), the surface modification treatment was given to one surface of the silicone rubber sheet 4a using the UV modification apparatus “VUM-307-F”, (trade name, manufactured by ORK Manufacturing Co., Ltd.), for 3 minutes. The integrated quantity of light of the UV treatment was 1450 mJ/cm², determined by the integrating actionometer “UV-350”, (trade name, manufactured by ORK Manufacturing Co., Ltd.). The method for surface modification treatment is not necessarily the above UV treatment, and may be corona treatment, plasma treatment, and ITRO treatment. The ITRO treatment is a kind of flame treatment, and it conducts surface treatment using a flame formed by a fuel gas containing a silane compound. By the ITRO treatment, a large quantity of nano-level particles consisting essentially of SiO₂ is formed on the surface being treated. The nano-level particles also contain Si—OH bond. With the presence of —OH group on the nano-level particles, the hydrophilic property of the treating surface increases to improve the wet index. For the case of surface modification of silicone rubber, ITRO treatment among the flame treatments is effective.

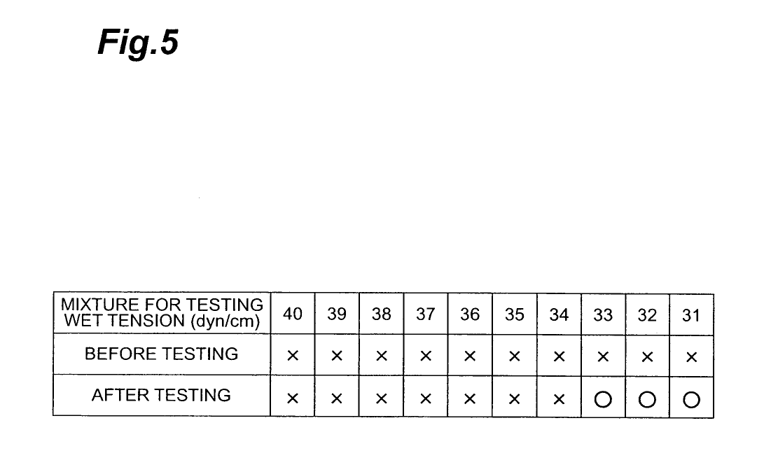

Here, the determination of wet tension (dyn/cm) on the silicone rubber sheet 4a before and after the UV treatment gave a result shown in FIG. 5. The judgment was done by No. 31.0 to No. 40.0 of the Testing Mixture for Wet Tension, (trade name, manufactured by Wako Pure Chemical Industries, Ltd.). The judgment could not determine the established wet condition of the surface of silicone rubber sheet 4a before the UV treatment for all the Testing Mixtures No. 31 to No. 40. On the other hand, after the UV treatment, the Testing Mixtures No. 31 to No. 33 gave judgment of established wet condition on the surface of the silicone rubber sheet 4a. Consequently, it is concluded that the wet tension before the UV treatment is less than 31 (dyn/cm) and that the wet tension after the UV treatment is about 33 (dyne/cm).

Next, as shown in FIG. 3(c), the EL element 5 was formed on the surface-modified surface of the silicone rubber sheet 4a using the wet method. That is, on the surface of surface-modified silicone rubber sheet 4a, there were formed sequentially the transparent electrode 54, the light-emitting layer 53, the dielectric layer 52, and the counter electrode 51.

Next, the sheet composed of the silicone rubber sheet 4a and the EL element 5, formed in the steps from FIG. 3(a) to FIG. 3(c), was placed in the mold. After that, the raw material mixture of 1:1 by weight of the silicone rubber “KE-1950A” (trade name, manufactured by Shin-Etsu Chemical Co., Ltd.), and the silicone rubber “KE-1950B”, (trade name, manufactured by Shin-Etsu Chemical Co., Ltd.) was filled in the mold. Then, the raw material mixture in the mold was heated and pressed at 125° C. under 50 kgf/cm² for 2 minutes. The treatment formed the silicone rubber sheet 4b having the protrusion 41 on the upper surface of the EL element 5, as shown in FIG. 4(a). The silicone rubber filled in the mold is preferably in a liquid state. The treatment can prevent the deformation of sheet formed in the steps of FIGS. 3(a) to 3(c), and composed of the silicone rubber sheet 4a and the EL element 5.

Next, as shown in FIG. 4(b), an adhesive was applied onto the upper surface of the silicone rubber sheet 4a at the side having no protrusion 41, thus the adhesion layer 3 was formed thereon by the wet method. The adhesion layer 3 may be formed by applying an adhesive, or may be formed by attaching a two-sided tape.

Then, as shown in FIG. 4(c), the key top part 2 made of a resin was placed on the upper surface of the adhesion layer 3, thus fixing the key top part 2 on the silicone rubber sheet 4a.

### EXAMPLE 2

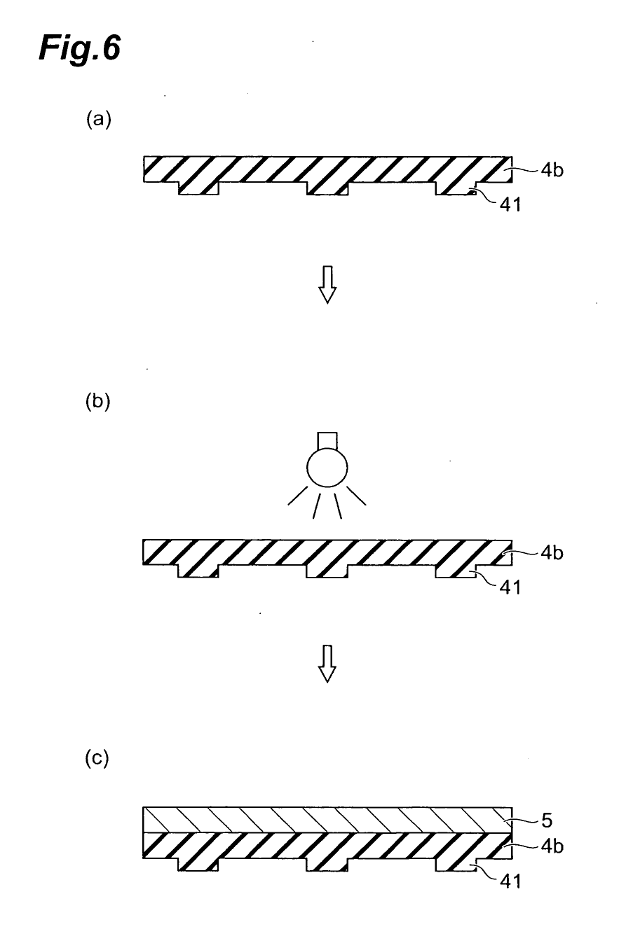

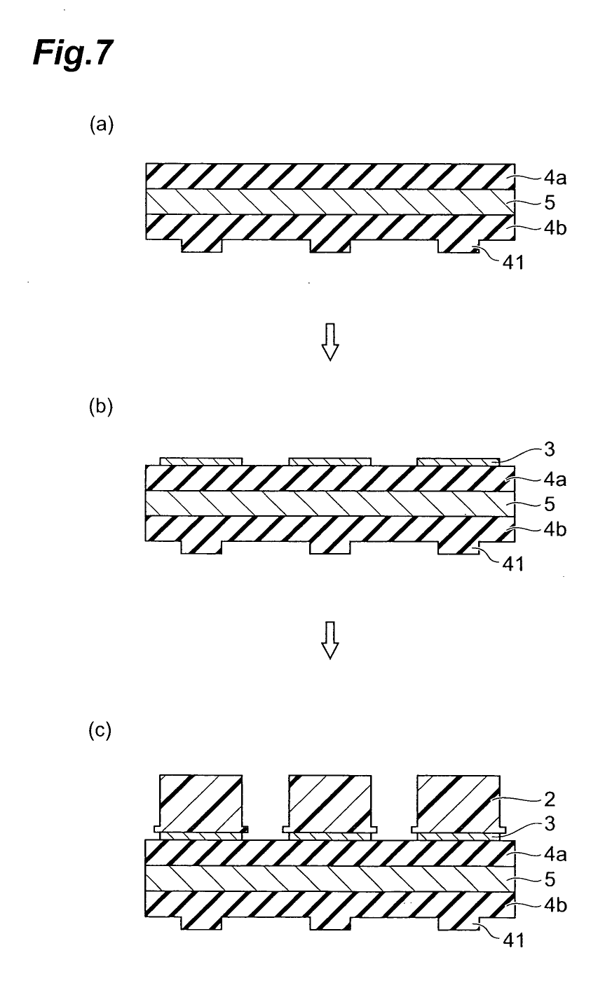

Referring to FIG. 6 and FIG. 7, Example 2 of the pushbutton switch cover member in the first embodiment is described. In Example 2, the description is limited to the process different from the process described in Example 1, and the same process to that of Example 1 is omitted.

First, into a specified mold, there was filled a blended raw material mixture of 100 parts by weight of silicone rubber “KE-951U” (trade name, manufactured by Shin-Etsu Chemical Co., Ltd.), 1 part by weight of crosslinking agent “C-8B” (trade name, manufactured by Shin-Etsu Chemical Co., Ltd.), and 0.004 parts by weight of “Color MB” (trade name, manufactured by Shin-Etsu Chemical Co., Ltd.). The filled raw material mixture was heated and pressed at 180° C. under 200 kgf/cm² for 5 minutes, thus obtained the silicone rubber sheet 4b having the protrusion 41 on one surface thereof, as shown in FIG. 6(a).

Next, as shown in FIG. 6(b), the surface modification treatment was given to a surface of the silicone rubber sheet 4b at the side not forming the protrusion 41 using the UV modification apparatus “VUM-307-F” (trade name, manufactured by ORK Manufacturing Co., Ltd.) for 3 minutes. The integrated quantity of light of the UV treatment was 1450 mJ/cm², determined by the integrating actionometer “UV-350” (trade name, manufactured by ORK Manufacturing Co., Ltd.). The wet tension on the silicone rubber sheet 4b before and after the UV treatment was the same as that in Example 1 so that the description is omitted.

Next, as shown in FIG. 6(c), the EL element 5 was formed on the surface-modified surface of the silicone rubber sheet 4b using the wet method. That is, on the surface of surface-modified silicone rubber sheet 4b, there were formed sequentially the counter electrode 51, the dielectric layer 52, the light-emitting layer 53, and the transparent electrode 54.

Next, the sheet composed of the silicone rubber sheet 4b and the EL element 5, formed in the steps of FIG. 6(a) to FIG. 6(c), was placed in the mold. After that, the raw material mixture of 1:1 by weight of the silicone rubber “KE-1950A” (trade name, manufactured by Shin-Etsu Chemical Co., Ltd.) and the silicone rubber “KE-1950B” (trade name, manufactured by Shin-Etsu Chemical Co., Ltd.) was filled in the mold. Then, the raw material mixture filled in the mold was heated and pressed at 125° C. under 50 kgf/cm² for 2 minutes. The treatment formed the silicone rubber sheet 4a on the upper surface of the EL element 5, as shown in FIG. 7(a). In the step shown in FIG. 7(a), the above silicone rubber filled in the mold is preferably a liquid silicone rubber in order to prevent the deformation of sheet, formed in the steps of FIGS. 6(a) to 6(c), composed of the silicone rubber sheet 4b and the EL element 5.

The steps of FIG. 7(b) and FIG. 7(c) are the same as those of FIG. 4(b) and FIG. 4(c) described in Example 1 so that the description thereof is omitted.

The above examples gave the surface modification only on the surface of the silicone rubber sheet to which any one of surfaces of the EL element 5 is adhered. The surface to be surface-modified is, however, not limited to the above surface. For example, the surface modification may be given to each of the surfaces of silicone rubber sheets 4a, 4b, to which both surfaces of the EL element 5 are adhered, respectively.

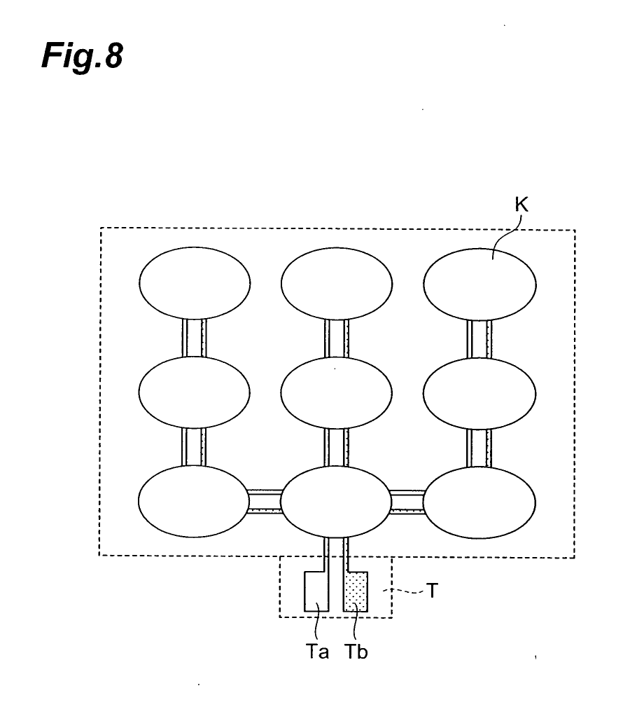

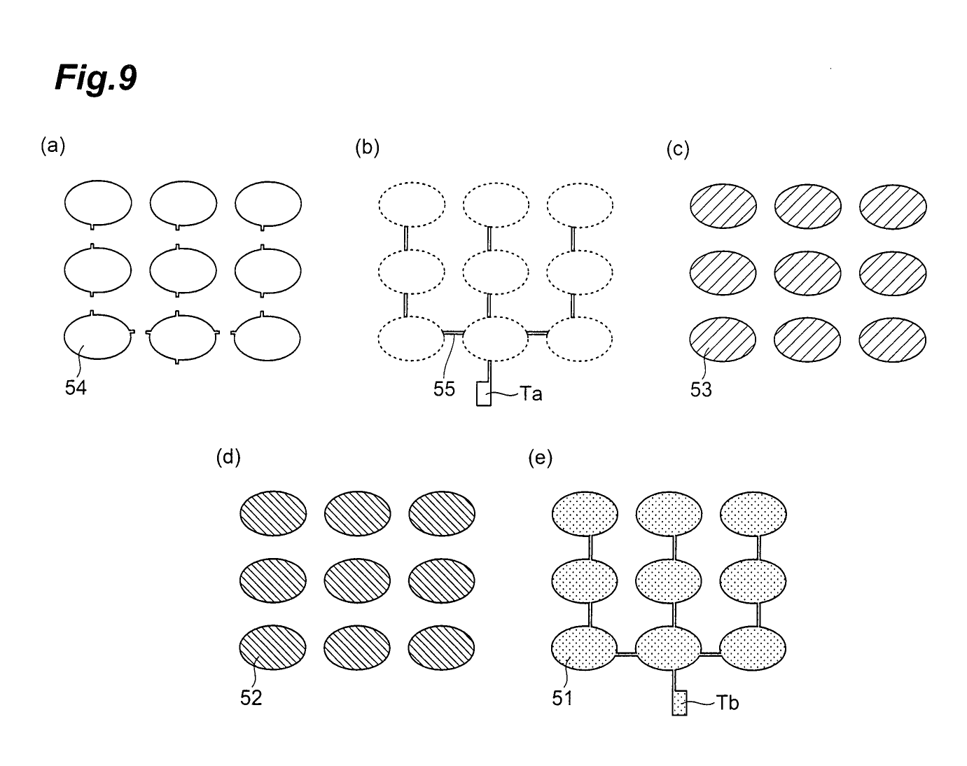

Now, referring to FIG. 8 and FIG. 9, the description is given to detail structural examples of applying the pushbutton switch cover member 1 manufactured by the above Examples to the pushbutton switch of cell-phone. FIG. 8 is a plan view of the pushbutton switch cover member 1 used to a pushbutton switch of a cell-phone. To the individual key parts K in FIG. 8, the individual EL elements 5 (FIGS. 9(a) to 9(e)) are formed. The EL element 5 has a structure of lamination of, in a sequent order from top, the transparent electrode 54 (FIG. 9(a)), the auxiliary electrode 55 (FIG. 9(b)), the light-emitting layer 53 (FIG. 9(c)), the dielectric layer 52 (FIG. 9(d)), and the counter electrode 51 (FIG. 9(e)). The auxiliary electrode 55 is formed so as to partially overlay the transparent electrode 54 at each key part K.

Respective transparent electrodes 54 are continuously wired with each other by the respective auxiliary electrodes 55. An end of the auxiliary electrode 55 is connected to a terminal Ta of a terminal part T. Counter electrodes 51 are continuously wired with each other. An end of the counter electrode 51 is connected to a terminal Th of the terminal part T. The terminal part T is structured by two-pole terminals Ta, Tb. The terminal part T exposes from the silicone rubber sheet which is used for the pushbutton switch cover member 1. By exposing the terminal part T from the silicone rubber sheet, the power supply from the terminal T to the EL element 5 is attained. The method to form the two-pole terminals may be the method of applying a conductive material similar to that of the counter electrode 51, or may be the method of adhering a metal piece by an anisotropic conductive adhesive. Between the transparent electrode 54 and the counter electrode 51, there is maintained a specific insulation.

On thus formed EL element 5, the fluorescence material in the light-emitting layer 53 is excited to emit light under the applied alternate voltage on the light-emitting layer 53 formed between the transparent electrode 54 and the counter electrode 51. As a result, the light emitted from the light-emitting layer 53 is irradiated from the upper surface of each key part K. That is, for the pushbutton switch shown in FIG. 8, each key part K becomes the light-emitting zone.

The detail structure of the pushbutton switch cover member 1 is not limited to the example of FIG. 8. For instance, two-pole terminals may be located to each light-emitting zone. With that structure, the light-emitting timing at each light-emitting zone can be differentiated. For the case that the transparent electrode assures a constant power feed capacity, the auxiliary electrode is not necessarily applied. Instead of using the auxiliary electrode, the transparent electrodes may be connected with each other.

### Second Embodiment

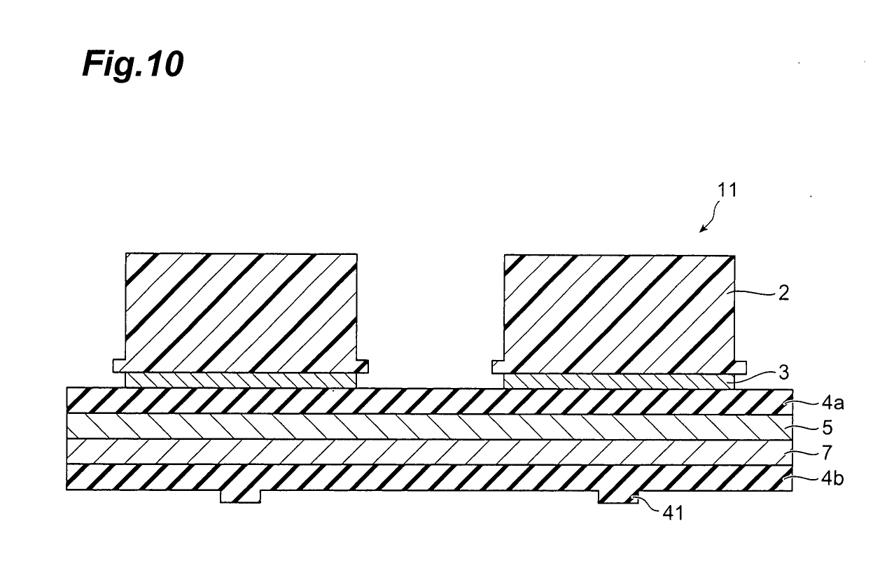

The second embodiment according to the present invention is described below. FIG. 10 is a cross sectional view of the pushbutton switch cover member according to the second embodiment. As seen in FIG. 10, the pushbutton switch cover member 11 in the second embodiment differs from the pushbutton switch cover member 1 of the first embodiment at the point of further forming a urethane layer 7 between the silicone rubber sheet 4b at the side of protrusion 41 and the EL element 5. Since other structural portions are similar to those of the pushbutton switch cover member 1 of the first embodiment, each structural element has the same symbol to that of corresponding element, and the description thereof is omitted. The following description gives detail of the differences from the first embodiment. Similar to the first embodiment, the sandwiching materials for the EL element 5 are not necessarily the silicone rubber sheets, and any kind is applicable if only it is a rubber sheet. Furthermore, the portion corresponding to the silicone rubber 4a in FIG. 10 is not limited to the rubber sheet, and any kind is applicable if only it is an elastic layer consisting essentially of an elastic material such as a silicone rubber, a thermoplastic elastomer, and a urethane-based resin.

The urethane layer 7 is formed by a urethane-based paint. By forming the urethane layer 7, the close contact between the silicone rubber sheet 4b and the EL element 5 becomes strong, thus increasing the adhesiveness. As a result, the durability of product service improves. In addition, by forming the EL element 5 on the urethane layer 7, the applicable kinds of the resin binder for the ink that forms the EL element 5 increase, which can improve the mass-productivity of the EL element 5.

### EXAMPLE 3

Next, the description for the examples of the pushbutton switch cover member in the second embodiment is given below.

Similar to Example 2 of the first embodiment 1, (FIG. 6(a)), the silicone rubber sheet 4b having the protrusion 41 on a surface thereof was formed.

Then, similar to Example 2 described above, (FIG. 6(b)), UV treatment was given to the surface of the silicone rubber sheet 4b at the surface not forming the protrusion 41, thus conducted the surface modification. The method of surface modification is not limited to the UV treatment, and, for instance, corona treatment, plasma treatment, and ITRO treatment may be given.

Next, onto the surface of the silicone rubber sheet 4 after the surface modification, there was applied an amine-based primer of a 1:1 mixture of “KBP-40” (trade name, manufactured by Shin-Etsu Chemical Co., Ltd.) and toluene.

Next, onto the surface after applying the amine-based primer, there was applied a urethane-based paint prepared by mixing 100 parts by weight of base resin “SO-1501 Clear” (trade name, manufactured by Dainichiseika Color & Chemicals Mfg. Co., Ltd.), 13 parts by weight of diluent “EU-IF” (trade name, manufactured by Dainichiseika Color & Chemicals Mfg. Co., Ltd.), and 15 parts by weight of curing agent “EN-2” (trade name, manufactured by Dainichiseika Color & Chemicals Mfg. Co., Ltd.). The applied mixture was then subjected to thermosetting at 150° C. for 45 minutes to form the urethane layer 7.

On the surface of thus formed urethane layer 7, there were formed sequentially: the EL element 5, the silicone rubber sheet 4a, the adhesion layer 3, and the key top part 2, similar to Example 2 described above.

Both the surface modification treatment and the primer treatment were given onto the silicone rubber sheet 4b. However, both of them are not necessarily given, and only any of them may be given.

1. A method for manufacturing a cover member for push button switch having an illumination function, comprising:
a first step of modifying any of the surfaces of an elastic layer consisting essentially of an elastic material;
a second step of forming an EL element on the modified surface of the elastic layer;
a third step of forming a rubber sheet on a surface of the EL element; and
a fourth step of fixing a key top part onto a surface of the elastic layer, wherein
a protrusion is formed on a surface of the rubber sheet opposite to the surface thereof adhering to the EL element.

2. A method for manufacturing a cover member for push button switch having an illumination function, comprising:
a first step of modifying one surface having no protrusion formed thereon of a rubber sheet, which rubber sheet forms the protrusion on the other surface thereof;
a second step of forming an EL element on the modified surface of the rubber sheet;
a third step of forming an elastic layer consisting essentially of an elastic material on a surface of the EL element; and
a fourth step of fixing a key top part onto a surface of the elastic layer.

3. A method for manufacturing a cover member for push button switch having an illumination function, comprising:
a first step of forming a urethane layer on one surface having no protrusion formed thereon of a rubber sheet, which rubber sheet forms the protrusion on the other surface thereof;
a second step of forming an EL element on a surface of the urethane layer;
a third step of forming an elastic layer consisting essentially of an elastic material on a surface of the EL element; and
a fourth step of fixing a key top part onto a surface of the elastic layer.

4. The method for manufacturing a cover member for push button switch having an illumination function according to claim 3, wherein the first step modifies the other surface and forms the urethane layer on the modified surface.

5. The method for manufacturing a cover member for push button switch having an illumination function according to claim 4, wherein the first step applies a primer on the modified surface and forms the urethane layer on the primer-applied surface.

6. The method for manufacturing a cover member for push button switch having an illumination function according to claim 3, wherein the first step applies a primer on the other surface and forms the urethane layer on the primer-applied surface.

7. A cover member for push button switch having an illumination function, comprising:
a rubber sheet having a protrusion formed at a lower surface side thereof;
an EL element being formed at an upper surface side of the rubber sheet;
an elastic layer being formed on an upper surface side of the EL element and consisting essentially of an elastic material; and
a key top part being fixed to an upper surface side of the elastic layer.

8. The cover member for push button switch according to claim 7, further comprising a urethane layer being formed between the rubber sheet and the EL element.

9. The cover member for push button switch according to claim 7, wherein the elastic material is a silicone rubber, a thermoplastic elastomer, or a urethane-based resin.

10. The cover member for push button switch according to claim 8, wherein the elastic material is a silicone rubber, a thermoplastic elastomer, or a urethane-based resin.
